(19) United States
(12) Patent Application Publication
(10) Pub. No.: US 2007/0287939 A1
(43) Pub. Date: Dec. 13, 2007

(54) EXERCISING APPARATUS FOR BODY LIPOLYSIS AND STRENGTHENING MUSCLES

(75) Inventor: Jong-Hwan Kim, Bucheon (KR)

Correspondence Address: CANTOR COLBURN, LLP, 55 GRIFFIN ROAD SOUTH, BLOOMFIELD, CT, 06002, US

(73) Assignee: HUMAN MEDEXTEC CO. LTD., Bucheon (KR)

(21) Appl. No.: 11/752,399

(22) Filed: May 23, 2007

(30) Foreign Application Priority Data
Nov. 16, 2004 (KR) 10-2004-0093342

(51) Int. Cl. A61H 1/00; A63B 22/16

(52) U.S. Cl. 601/35

(57) ABSTRACT

An exercising apparatus capable of implementing an exercise effect by contracting and relaxing a user's muscles. The apparatus comprises: a moving unit having a pair of moving panels of which both ends respectively perform a seesaw motion by being alternatively reciprocated upward and downward; an up-and-down reciprocating unit coupled to at least one of both ends of the moving panels, for performing a seesaw motion; and a driving unit connected to the up-and-down reciprocating unit, for driving the up-and-down reciprocating unit to reciprocate upward and downward.

### BACKGROUND OF THE INVENTION

1. Field of the Invention

The present disclosure relates to an exercising apparatus, and more particularly, to an exercising apparatus capable of implementing exercise effect by contracting and relaxing a user's muscles.

2. Description of the Background Art

An exercising apparatus is an apparatus with which a user exercises by contracting and relaxing the muscles. As examples of an exercising apparatus, there is running machine, stationary bicycle, stepper, etc. as well as callisthenic iron dumbbell or dumbbell.

Meanwhile, the conventional exercising apparatus has a problem that a user should actively move by himself/herself by using his/her physical strength in order to take exercise.

In particular, the conventional exercising apparatus needs a user's active motion, so that a disabled person unable to actively move cannot use the exercising apparatus.

### SUMMARY OF THE INVENTION

Therefore, an object of the present disclosure to provide an exercising apparatus which needs not a user's active motion.

Another object of the present disclosure is to provide an exercising apparatus which stably supports a user's hand or foot and performs a seesaw motion.

Still another object of the present disclosure is to provide an exercising apparatus which stably supports a user's hand or foot and performs an up and down motion.

To achieve these and other advantages and in accordance with the purpose of the present disclosure, as embodied and broadly described herein, there is provided an exercising apparatus, comprising: a moving unit having a pair of moving panels of which both ends respectively perform a seesaw motion by being alternatively reciprocated upward and downward; an up-and-down reciprocating unit coupled to at least one of both ends of the moving panels, for performing a seesaw motion; and a driving unit connected to the up-and-down reciprocating unit, for driving the up-and-down reciprocating unit to reciprocate upward and downward.

The up-and-down reciprocating unit comprises: a driving unit connecting shaft for receiving rotation force generated from the driving unit; an eccentric rotation unit eccentrically-connected to the driving unit connecting shaft, the eccentric rotation unit having a first eccentric rotation shaft and a second eccentric rotation shaft disposed to have an angular difference of 180° from each other; and a first link unit and a second link unit respectively having one end hinge-coupled to the respective other ends of the moving panels, and the other end rotatably coupled to the first and the second eccentric rotation shafts.

The up-and-down reciprocating unit may be installed at one end or both ends of each moving panel.

The respective up-and-down reciprocating units installed at both ends of the moving panels may be connected to each other by a linking unit so that a driving force can be transmitted from the one up-and-down reciprocating unit connected to the driving unit to the other up-and-down reciprocating unit facing the one the up-and-down reciprocating unit connected to the driving unit.

The linking unit may be configured as a link member having one end rotatably coupled to the one up-and-down reciprocating unit disposed at one ends of the moving panels, and the other end rotatably coupled to the up-and-down reciprocating unit disposed at the other ends of the moving panels.

The linking unit may comprise pulleys disposed at one pair of the up-and-down reciprocating units; and a belt for connecting the pulleys.

Balance weights having centers of gravity having an angular difference of 180° centering an axis of the driving unit connecting shaft from an axis of the first eccentric rotation shaft are installed at the up-and-down reciprocating unit. The linking unit may comprise coupling pins disposed at the balance weights with an angular difference of 180° centering the axis of the first eccentric rotation shaft from the axis of the driving unit connecting shaft; and a link member rotatably coupled to the coupling pins.

Both ends of the eccentric rotation unit may be connected to a concentric shaft concentric with the driving unit connecting shaft.

The concentric shaft may be rotatably supported by a shaft supporting bracket.

A balance weight eccentrically connected to the concentric shaft may be further disposed at one end of the concentric shaft.

The driving unit connecting shaft may be connected to a driving shaft of the driving unit by a coupler.

The driving unit connecting shaft may be configured to receive rotation force from the driving unit through a belt.

The driving unit may be disposed at a central portion of the moving unit and the driving shaft of the driving unit may be connected to the driving unit connecting shaft by a rotation shaft transmitting unit.

The rotation shaft transmitting unit may be implemented as a belt or a link member for connecting the driving unit connecting shaft and the driving shaft to each other.

The rotation shaft transmitting unit may comprise: a main rotation shaft connected to the driving shaft; a main shaft supporting bracket for rotatably supporting the main rotation shaft; a first eccentric rotation shaft connected to the main rotation shaft, and eccentric from the main rotation shaft; a second eccentric rotation shaft eccentric from the main rotation shaft; and first and second link members having both ends rotatably coupled to the first and the second eccentric rotation shafts.

The first eccentric rotation shaft and the second eccentric rotation shaft may be disposed to have an angular difference of 180° centering an axis of the main rotation shaft.

The driving units may be coupled to the respective driving unit connecting shafts of the moving units.

The up-and-down reciprocating unit may comprise: a concentric shaft rotatably supported by shaft supporting bracket; first and second eccentric rotation shafts eccentrically coupled to respective ends of the concentric shaft, and having an angular difference of 180° with each other; and a link unit having one ends rotatably coupled to the first and the second eccentric rotation shafts, and the other ends hinge-coupled to the first and the second moving panels, wherein the driving unit is coupled to one of the concentric shaft and the first eccentric rotation shaft so as to transmit rotation force.

The driving shaft of the driving unit may be connected to the concentric shaft by a rotation force transmitting unit thus to transmit rotation force to the concentric shaft.

### BRIEF DESCRIPTION OF THE DRAWINGS

FIG. 1 is a perspective view showing an exercising apparatus according to the present invention;

FIG. 2 is a disassembled view of the exercising apparatus of FIG. 1;

FIG. 3 is a disassembled view showing a main part of the exercising apparatus of FIG. 1;

FIG. 4 is a disassembled view showing an up-and-down reciprocating unit of the exercising apparatus of FIG. 1;

FIG. 5 is a plane view showing a main part of the exercising apparatus of FIG. 1;

FIG. 6a is a side view showing a moving unit of the exercising apparatus of FIG. 1;

FIG. 6b is a side view showing a modified moving unit of the exercising apparatus of FIG. 1;

FIG. 7 is a front view showing a modified exercising apparatus of FIG. 1;

FIG. 8 is a front view showing another modified exercising apparatus of FIG. 1;

FIG. 9 is a plane view showing the exercising apparatus of FIG. 7;

FIG. 10a is a side view showing a modified up-and-down reciprocating unit of the exercising apparatus of FIG. 1;

FIG. 10b is a side view showing another modified up-and-down reciprocating unit of the exercising apparatus of FIG. 1;

FIG. 11a is a plane view showing a modified up-and-down reciprocating unit of the exercising apparatus of FIG. 1; and

FIG. 11b is a front view showing a main member of the exercising apparatus of FIG. 11a.

### DETAILED DESCRIPTION OF THE INVENTION

Reference will now be made in detail to the preferred embodiments of the present disclosure, examples of which are illustrated in the accompanying drawings.

Hereinafter, an exercising apparatus will be explained in more detail.

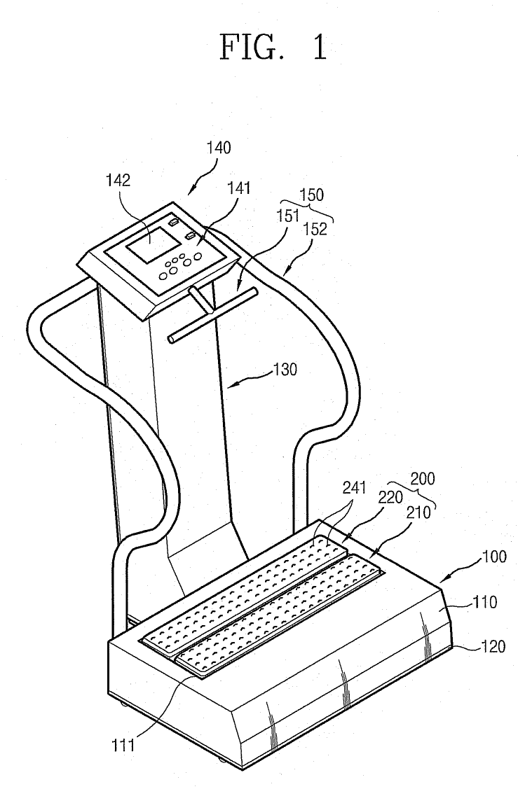

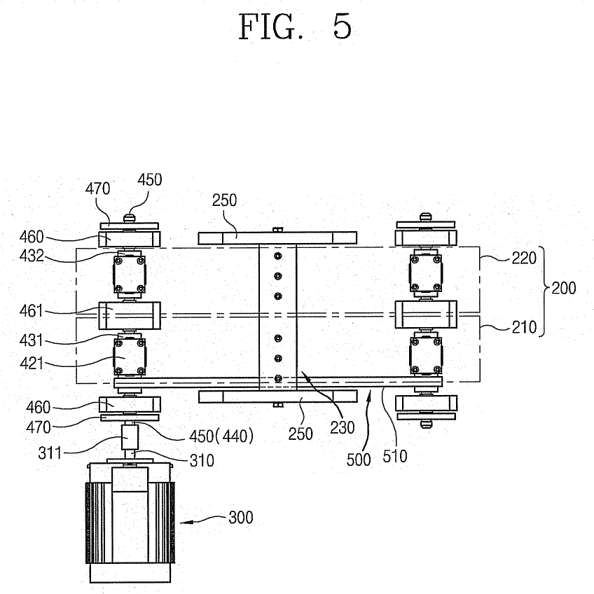

As shown in FIGS. 1 to 9, the exercising apparatus according to the present invention comprises: a moving unit 200 having a first moving panel 210 and a second moving panel 220, and performing a seesaw motion as one end of the first moving panel 210 and one end of the second moving panel 220 are alternatively reciprocated upward and downward; an up-and-down reciprocating unit 400 coupled to at least one of both ends of the first and the second moving panels, for performing a seesaw motion; and a driving unit 300 connected to the up-and-down reciprocating unit 400, for driving the up-and-down reciprocating unit 400 to reciprocate upward and downward.

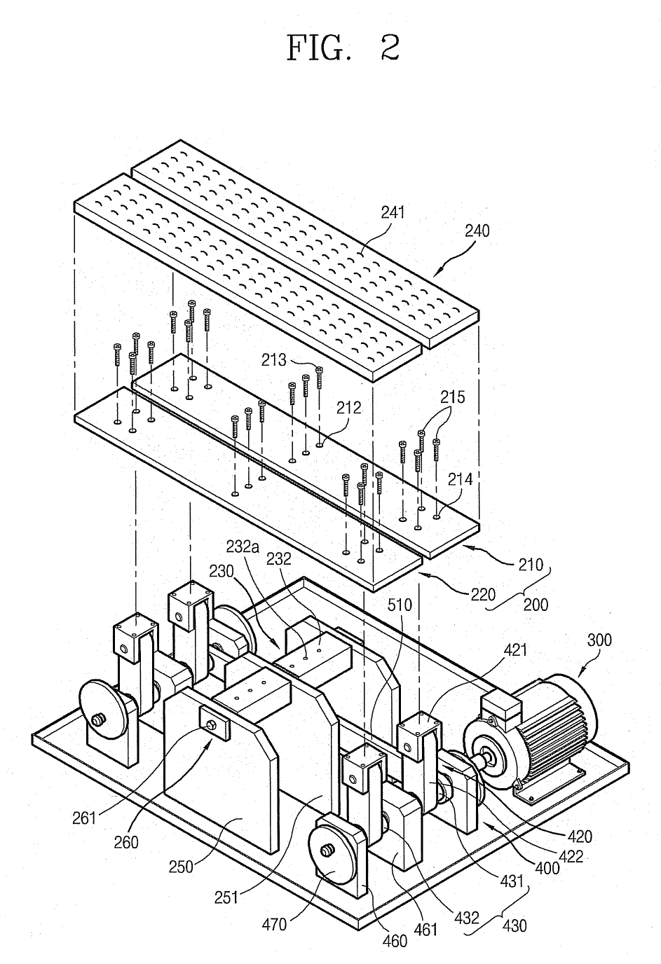

As shown in FIGS. 1 and 2, the exercising apparatus comprises a body 100 having a receiving space for receiving the driving unit 300 and the up-and-down reciprocating unit 400.

As shown in FIG. 1, the body 100 includes a cover unit 110 having an opening 111 for installing the moving unit 200, and a bottom unit 120 coupled to the cover unit 110 and forming the receiving space.

A post 130 having a control unit 140 for controlling a motion of the up-and-down reciprocating unit 400 by controlling the driving unit 300 is connected to one side of the body 100. The position of the control unit 140 may be variously modified according to a user's convenience.

The control unit 140 is comprised of a panel, and includes a manipulating portion 141 having buttons for a users' control of the driving unit 300; a controlling circuit (not shown) having a control program therein, the control program preset according to a user's body condition such as a weight; a displaying portion 142 for displaying an exercise amount (calorie consumption amount) according to the control program; and a switch for turning on/off the driving unit 300 and the control unit 140.

A handgrip 150 grasped by a user who is exercising with his feet on the moving unit 200 may be further installed. As shown in FIG. 1, the handgrip 150 may be implemented as a first handgrip 151 connected to the controller 140, or a second handgrip 152 connected to the body 100. Both the first handgrip 151 and the second handgrip 152 may be installed, or one of the first and the second handgrips 151, 152 may be installed.

As shown in FIGS. 1 and 2, the moving unit 200 is disposed at the opening 111 of the cover unit 110 of the body 100 so as to be rotatably reciprocated.

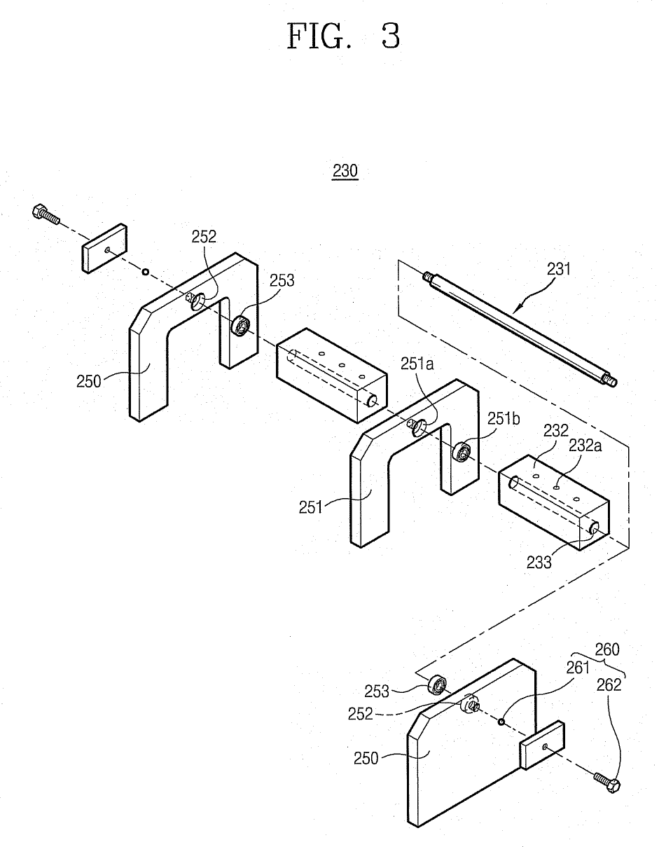

As shown in FIGS. 2 and 3, the moving unit 200 includes the first moving panel 210 and the second moving panel 220 parallel to each other in a longitudinal direction. The first moving panel 210 and the second moving panel 220 are configured to perform a seesaw motion as one end of the first moving panel 210 and one end of the second moving panel 220 are alternatively reciprocated upward and downward, that is, as one end of the second moving panel 220 downwardly moves while one end of the first moving panel 210 upwardly moves.

An angular difference between the first moving panel 210 and the second moving panel 220 of the moving unit 200 may have various angles rather than 180°, thereby providing various exercise effects to a user.

The first moving panel 210 and the second moving panel 220 are provided with one or more coupling holes 212 for inserting screws 213 at each central portion thereof so as to be coupled to a hinge unit 230 that will be later explained, and one or more coupling holes 214 for inserting screws 215 are formed at one or both ends of the first and the second moving panels 210, 220 so as to be coupled to a connecting unit 410.

A covering unit 240 for covering the coupling holes 212, 214 and enhancing comfort of a user's feet or hands is disposed on the first moving panel 210 and the second moving panel 220.

A plurality of protrusions 241 for providing acupressure effect to a user's feet or hands may be formed on the covering unit 240.

As shown in FIGS. 2 and 3, the hinge unit 230 includes a rotation shaft 231 rotatably installed at a supporting bracket 250 installed on the bottom unit 120, and a hinge member 232 respectively coupled to the first and the second moving panels 210, 220 for being inserted with the rotation shaft 231.

The hinge member 232 is formed with screw holes 232a for inserting the screws 215 so as to be coupled to the first and the second moving panels 210, 220, respectively. And the hinge member 232 includes a first hinge member 232 and a second hinge member 232 disposed to be separated from each other with respect to a rotation direction of the first and the second moving panels 210, 220, and each inserted into the rotation shaft 231.

Herein, a supplementary bracket 251 for stably supporting the rotation shaft 231 may be disposed between the first hinge member 232 and the second hinge member 232. As shown in FIG. 3, the rotation shaft 231 may be integrally formed thus to be inserted into inserting holes 233 disposed at the first and second hinge members 232. Also, the rotation shaft 231 may be implemented as a first rotation shaft (not shown) and a second rotation shaft (not shown) respectively inserted into the inserting holes 233 disposed at the first and the second hinge members 232.

Preferably, an inserting hole 251a for rotatably inserting the rotation shaft 231 (or the first rotation shaft and the second rotation shaft) is formed at the supplementary bracket 251. Preferably, a bearing 251b for smoothly rotating the rotation shaft 231 (or the first rotation shaft and the second rotation shaft) is disposed at the inserting hole 251a.

Preferably, the rotation shaft 231 is inserted into a coupling hole 252 formed at the supporting bracket 250. Preferably, a bearing 253 is disposed at the coupling hole 252 formed at the supporting bracket 250, thereby inserting the rotation shaft 231.

The hinge unit 230 is installed at a central portion of the moving unit 200. However, the installation position of the hinge unit 230 is not limited.

A movement preventing unit 260 for preventing the rotation shaft 231 from moving in a shaft direction may be further installed at the supporting bracket 250.

As shown in FIGS. 2 and 3, the movement preventing unit 260 may include a ball 261 contacting an end of the rotation shaft 231, and a male screw unit 262 coupled to the supporting bracket 250 so that the ball can maintain the contact state to the end of the rotation shaft 231. When the moving panel 200 is rotatably reciprocated, the rotation shaft 231 is prevented from moving in a shaft direction thereof by the movement preventing unit 260.

As shown in FIGS. 2 to 4, the up-and-down reciprocating unit 400 includes a driving unit connecting shaft 440 for receiving rotation force generated from the driving unit 300; an eccentric rotation unit 430 eccentrically-connected to the driving unit connecting shaft 440, and having first and second eccentric rotation shafts 431, 432 disposed to have an angular difference of 180° from each other; and a first link unit 420 and a second link unit 420 respectively having one ends hinge-coupled to one ends of the first moving panel 210 and the second moving panel 220, and the other ends rotatably coupled to the first and the second eccentric rotation shafts 431, 432.

The up-and-down reciprocating unit 400 may be installed at one side or both sides of the moving unit 200.

When the up-and-down reciprocating unit 400 is installed at both sides of the moving unit 200, the first and the second eccentric rotation shafts 431, 432 of the up-and-down reciprocating unit 400 disposed at one side of the moving unit 200 have an angular difference of 180° from the first and the second eccentric rotation shafts 431, 432 of the up-and-down reciprocating unit 400 disposed at the other side of the moving unit 200.

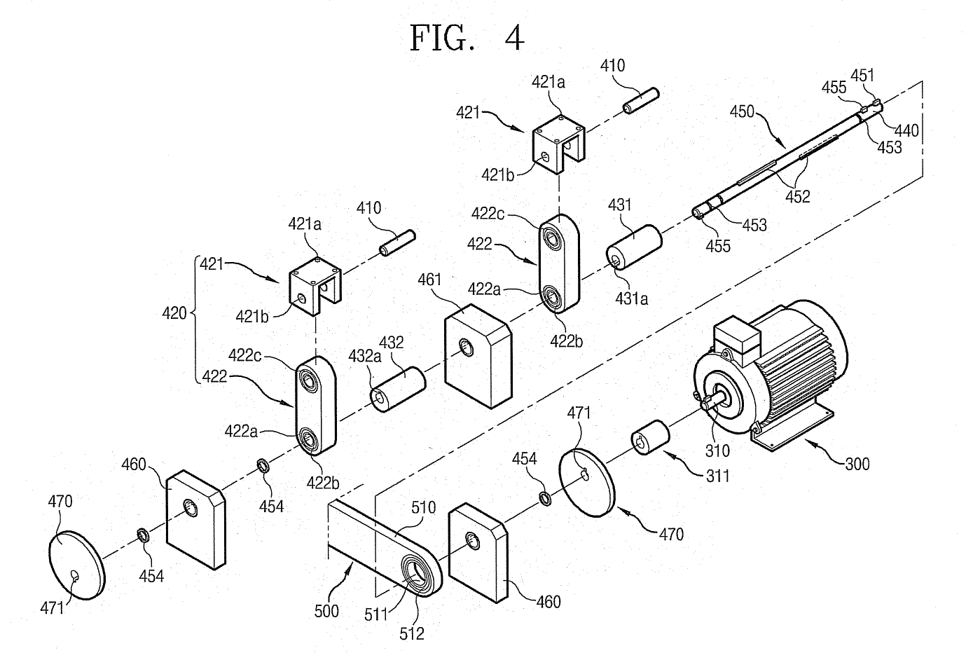

As shown in FIGS. 3 and 4, the driving unit connecting shaft 440 may be directly connected to the driving shaft 310 of the driving unit 300 by a coupler 311, or by a belt or a link member thus to be rotated.

The eccentric rotation unit 430 composed of the first eccentric rotation shaft 431 and the second eccentric rotation shaft 432 is eccentric from a rotation axis, thereby reciprocating the first link unit 420 and the second link unit 420 upward and downward, and reciprocating the first moving panel 210 and the second moving panel 220 respectively connected to the first link unit 420 and the second link unit 420 centering the hinge unit 230.

The first eccentric rotation shaft 431 and the second eccentric rotation shaft 432 may have various angular differences from each other as well as 180°.

The eccentric rotation unit 430 rotates by being connected to the driving unit connecting shaft 440, and may have various modifications by those skilled in the present invention. As shown in FIGS. 2 to 4, concentric shafts 450 concentric with the driving unit connecting shaft 440 may be connected to both ends of the eccentric rotation unit 430.

The concentric shaft 450 is rotatably supported by a shaft supporting bracket 460. As shown in FIG. 4, the driving unit connecting shaft 440 may be implemented as one of both ends of the concentric shaft 450.

As shown in FIGS. 2 to 4, one or more balance weights 470 eccentrically connected to the concentric shaft 450 may be further disposed at one of both ends of the concentric shaft 450. The balance weight 470 may be disposed inside or outside the shaft supporting bracket 460.

The balance weight 470 may reduce load of the driving unit 300 by preventing reverse torque generated by a user's weight.

As shown in FIG. 4, a coupling key 451 of the driving unit connecting shaft 440 and for coupling the concentric shaft 450 to a coupler 311 is disposed at one end of the concentric shaft 450. A coupling key 452 for coupling the first and the second eccentric rotation shafts 431, 432 is disposed at the concentric shaft 450 in correspondence to the first and the second eccentric rotation shafts 431, 432.

The first and the second eccentric rotation shafts 431, 432 are respectively formed with key grooves 431a and 432a for being inserting with the coupling keys 452.

As shown in FIG. 4, key grooves 453 for coupling keys 454 for fixing the first and the second eccentric rotation shafts 431, 432 may be formed at the concentric shaft 450.

A coupling key 455 for coupling the balance weight 470 is formed at the concentric shaft 450, and a key groove 471 for inserting the coupling key 455 is formed at the balance weight 470.

As shown in FIGS. 2 to 4, the first and the second link units 420 respectively include a connecting unit 421 having a coupling hole 421a for coupling the first and the second moving panels 210, 220 by a screw 215, and a coupling rod 422 having one end hinge-coupled to the connecting unit 421 and the other end rotatably coupled to the first and the second eccentric rotation shafts 431, 432.

As shown in FIG. 4, an inserting hole 422a for inserting the first and the second eccentric rotation shafts 431, 432 is formed at the connecting rod 422. A bearing 422b for smoothly rotating the first eccentric rotation shaft 431 or the second eccentric rotation shaft 432 is preferably disposed at the inserting hole 422a.

The connecting unit 421 may have various shapes, and as shown in FIGS. 2 to 4, has a ‘U’ shape so as to insert the coupling rod 422. An inserting hole 421b for inserting a hinge pin 410 inserted into an inserting hole 422c formed at the coupling rod 422 is disposed at the connecting unit 421, thereby coupling the connecting unit 421 and the coupling rod 422 to each other.

The first and the second link units 420 are disposed at each central portion of the first and the second moving panels 210, 220 in a width direction, and are implemented in one pair or in plurality, thereby stably supporting the first and the second moving panels 210, 220. As shown in FIGS. 2 to 6b, a linking unit 500 may be installed between the first link unit 420 and the second link unit 420, or may be connected to the first eccentric rotation shaft 431 or the second eccentric rotation shaft 432.

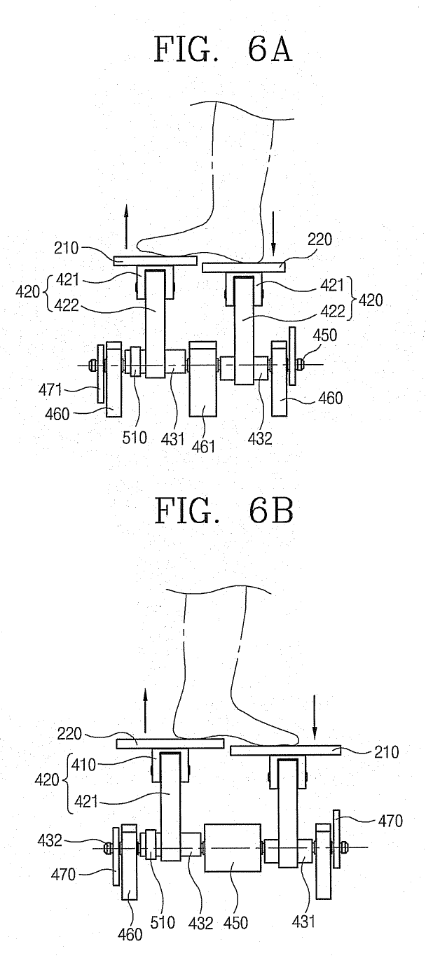

As shown in FIG. 6a, the concentric shaft 450 may be rotatably supported by a shaft supporting bracket 461 disposed on the bottom unit 120 between the first eccentric rotation shaft 431 and the second eccentric rotation shaft 432 so as to endure a user's weight.

The first eccentric rotation shaft 431 and the second eccentric rotation shaft 432 may be integrally formed with each other. As shown in FIG. 6b, a supplementary concentric shaft 456 for connecting the first and the second eccentric rotation shafts 431, 432 to each other may be further provided. Herein, the shaft supporting bracket 461 need not be necessarily provided.

The up-and-down reciprocating unit 400 may be installed at one end of the first and the second moving panels 210, 220, or as shown in FIGS. 2 to 4, may be installed at both ends of the first and the second moving panels 210, 220.

When the up-and-down reciprocating unit 400 is disposed at both ends of the moving unit 200, the first and the second eccentric rotation shafts 431, 432 of the up-and-down reciprocating unit 400 have an angular difference from each other. Accordingly, the first and the second moving panels 210, 220 can have a seesaw motion more smoothly.

As shown in FIGS. 2 to 6b, the up-and-down reciprocating unit 400 disposed at one end of the first and the second moving panels 210, 220 is connected to the up-and-down reciprocating unit 400 disposed at the other end of the first and second moving panels 210, 220 by the linking unit 500.

As shown in FIGS. 2 to 6b, the linking unit 500 may be composed of a connection link member 510 having one end rotatably coupled to the first eccentric rotation shaft 431 of the up-and-down reciprocating unit 400 connected to the driving unit 300, and the other end rotatably coupled to the first eccentric rotation shaft 431 of the up-and-down reciprocating unit 400 disposed at the other end of the moving unit 200.

The connection link member 510 may be coupled to the second eccentric rotation shaft 432, or may be implemented in plurality so as to be coupled to the first and second eccentric rotation shafts 431, 432, respectively.

As shown in FIGS. 2 to 4, the connection link member 510 includes an inserting hole 511 for inserting the first eccentric rotation shaft 431, and a bearing 512 for smoothly rotating the first eccentric rotation shaft 430. The connection link member 510 may be composed of a belt (not shown) for connecting pulleys (not shown) disposed at the first and the second eccentric rotating shafts 431, 432.

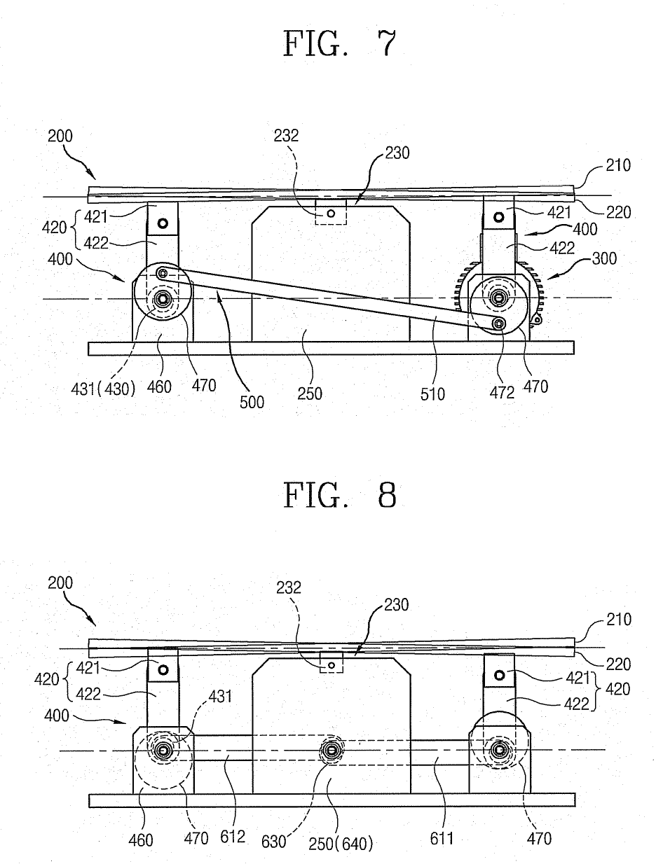

As shown in FIG. 7, when the balance weights 470 are installed, the connection link member 510 may be rotatably coupled to coupling pins 472 disposed at each balance weight 470 of each up-and-down reciprocating unit 400.

As shown in FIG. 7, the coupling pins 472 may be disposed to have an angular difference of 180° from the first eccentric rotation shaft 431, or may be disposed to have the same angular difference. The first and the second moving panels 210, 220 may have various widths, respectively. A user's one foot may be supported by the first moving panel 210, and the other foot may be supported by the second moving panel 220.

The driving unit 300 may be disposed at a central portion of the moving panel 200, and may be connected to the driving unit connecting shaft 440 by a belt (not shown) or by an additional connection mechanism.

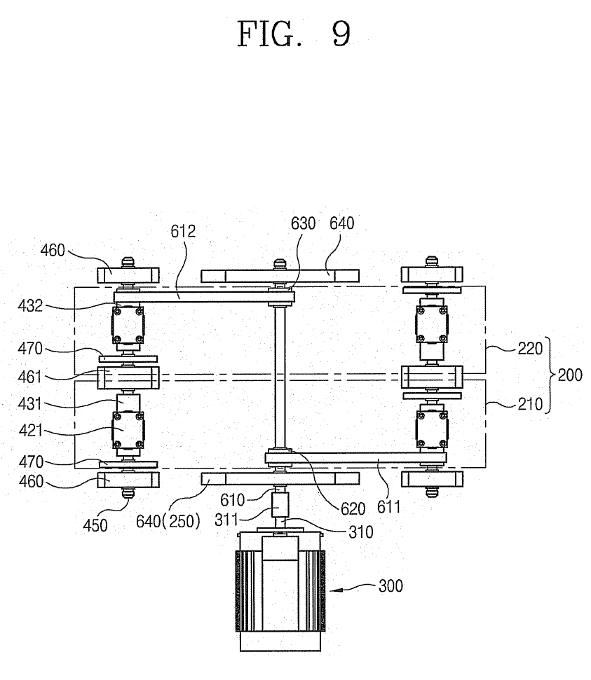

As shown in FIGS. 8 and 9, the driving unit 300 is disposed at a central portion of the moving unit 200. A rotation force transmitting unit 600 connected to the driving shaft 310 of the driving unit 300 for transmitting rotation force generated from the driving unit 300 to the driving unit connecting shaft 440 is disposed at a central portion of the moving unit 600.

The first eccentric rotation shaft 431 and/or the second eccentric rotation shaft 432 may serve as the driving unit connecting shaft 440.

The rotation shaft transmitting unit 600 may comprise: a main rotation shaft 610 connected to the driving shaft 310 of the driving unit 300; first and second eccentric rotation shafts 620, 630 eccentric from the main rotation shaft 610; and first and second link members 611, 612 for connecting the first eccentric rotation shaft 620 and the driving unit connecting shaft 440 of the up-and-down reciprocating unit 400, and the second eccentric rotation shaft 630 and the driving unit connecting shaft 440 of the up-and-down reciprocating unit 400 respectively.

The first and the second eccentric rotation shafts 620, 630 may have the same diameter, and may be disposed to have an angular difference of 180° centering an axis of the main rotation shaft 610 or disposed to have the same angular phase. The first and the second eccentric rotation shafts 620, 630 are connected to the first eccentric rotation shaft 431 of the same diameter, and have the same angle phase.

The first link member 611 connects the first eccentric rotation shaft 620 to the driving unit connecting shaft 440 of the moving unit 400, and the second link member 612 connects the second eccentric rotation shaft 630 to the driving unit connecting shaft 440 of the moving unit 400.

Preferably, the first and the second link members 611, 612 are respectively provided with a bearing for smoothly rotating the first eccentric rotation shaft 620, the second eccentric rotation shaft 630, and the driving unit connecting shaft 440.

As shown in FIGS. 8 and 9, the main rotation shaft 610 is rotatably supported by a main shaft supporting bracket 640 disposed at the bottom unit 120 of the body 100.

The first and the second link members 611, 612 may be configured as a belt, respectively. Pulleys (not shown) are disposed at the first eccentric rotation shaft 620, the second eccentric rotation shaft 630, and the driving unit connecting shaft 440 of the up-and-down reciprocating unit 400.

When the up-and-down reciprocating unit 400 is disposed at one side of the moving unit 200, only the first eccentric rotation shaft 431 and the first link member 610 may be implemented.

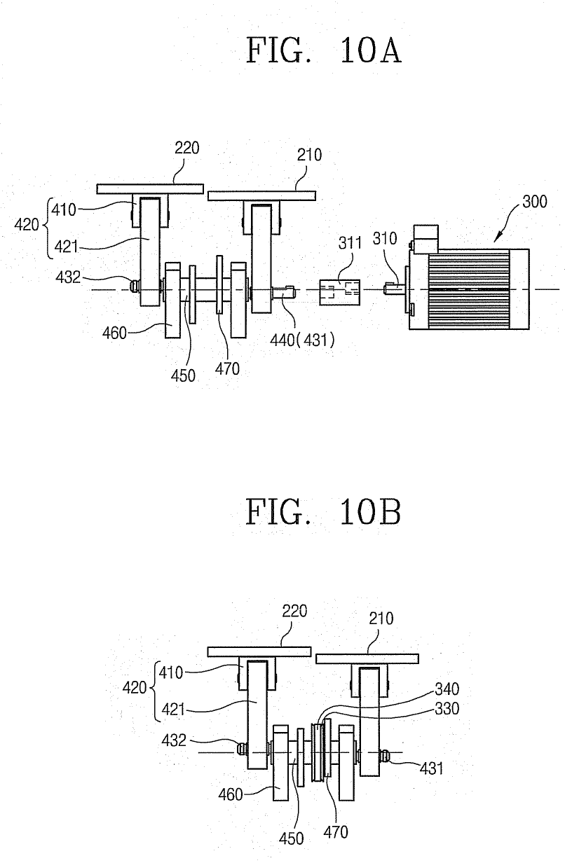

As shown in FIGS. 10a and 10b, the up-and-down reciprocating unit 400 includes: a driving shaft coupling unit 440 coupled to a coupler 311 eccentrically coupled to the driving shaft 310 of the driving unit 300, and eccentrically rotating from the driving shaft 310; and a link unit 420 having one end hinge-coupled to the other end of the moving unit 200 and the other end rotatably coupled to the driving shaft coupling unit 440.

As shown in FIGS. 10a and 10b, the up-and-down reciprocating unit 400 may comprise: a concentric shaft 450 rotatably supported by a shaft supporting bracket 460; first and second eccentric rotation shafts 431, 432 eccentrically coupled to both ends of the concentric shaft 450, respectively, and having an angular difference of 180° from each other; and a link unit 420 having one end rotatably coupled to the first and the second eccentric rotation shafts 431, 432, and the other end hinge-coupled to the first and the second moving panels 210, 220, wherein the driving unit 300 is coupled to one of the concentric shaft 450 and the eccentric rotation shaft 430 so as to transmit rotation force.

The driving shaft 310 of the driving unit 300 may be connected to the concentric shaft 450 by a rotation force transmitting unit thus to transmit rotation force to the concentric shaft 450.

As shown in FIG. 10a, the rotation force transmitting unit may be configured so that the driving shaft 310 of the driving unit 300 can be coupled to the eccentric rotation shaft 430 by the coupler 311.

As shown in FIG. 10b, the rotation force transmitting unit may include a belt for connecting pulleys coupled to the driving shaft 310 and the concentric shaft 450 to each other.

As shown in FIG. 10a, the concentric shaft 450 may be rotatably supported by one or more shaft supporting brackets 460. As shown in FIGS. 10a and 10b, a balance weight 460 for attenuating an inverse moment due to a user's weight may be further disposed at the concentric shaft 450.

As shown in FIG. 10a, driving force generated from the driving unit 300 may be directly transmitted to the up-and-down reciprocating unit 400. As shown in FIG. 10b, the driving force may be indirectly transmitted to the up-and-down reciprocating unit 400 by a belt 340 and a pulley 330. That is, as the belt 340 is coupled to the driving shaft of the driving unit 300, rotation force generated from the driving shaft 310 of the driving unit 300 is transmitted to the pulley 330 through the belt 340 thereby rotating the concentric shaft 450.

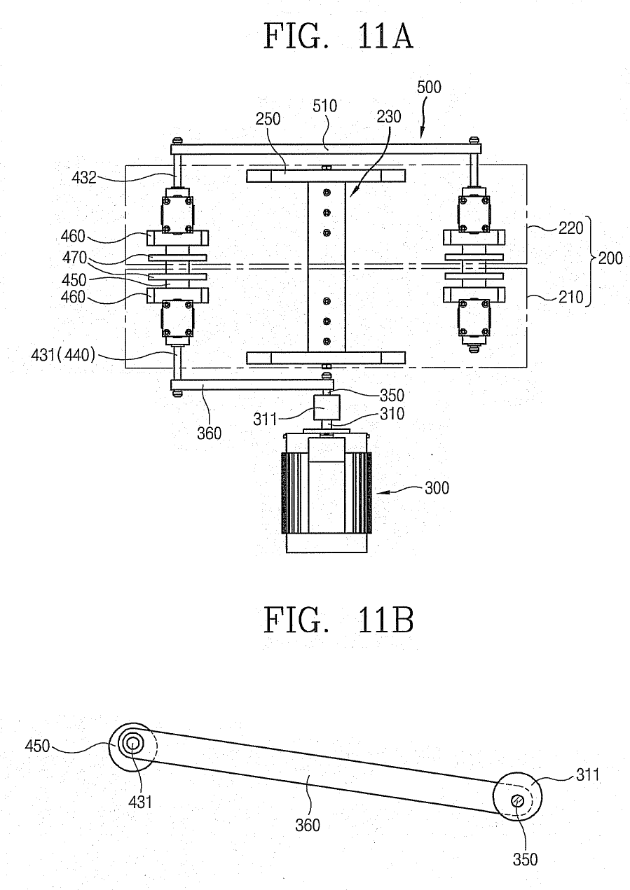

As shown in FIGS. 11a and 11b, the rotation force transmitting unit may be configured as a link member 360 having one end rotatably coupled to the first eccentric rotation shaft 431, and the other end rotatably coupled to an eccentric coupling shaft 350 eccentrically coupled to the driving shaft 310 of the driving unit 300.

The rotation force transmitting unit may include a belt for connecting pulleys (not shown) coupled to the first eccentric rotation shaft 431 and the eccentric coupling shaft 350.

In the exercising apparatus of the present invention, once a user's feet or hands are put on the moving unit, the moving unit is rotatably reciprocated under the control of the control unit. Accordingly, exercise effects such as the user's body lipolysis and muscle strengthening are implemented.

Furthermore, since the first and the second moving panels 210, 220 perform an alternative up-and-down reciprocating motion, the user can experience various exercising patterns.

Also, in the present invention, exercise effects such as a user's body lipolysis and muscle strengthening are implemented without the user's active motion.

Also, even a disabled person such as a lower part paralysis can experience various exercise effects.

Besides, the moving unit that performs a rotatable reciprocation within a certain angular interval may be implemented in plurality thus to allow the user to experience various exercising patterns.

What is claimed is:

1. An exercising apparatus, comprising:
a moving unit having a pair of moving panels of which both ends respectively perform a seesaw motion by being alternatively reciprocated upward and downward;
an up-and-down reciprocating unit coupled to at least one of both ends of the moving panels, for performing a seesaw motion; and
a driving unit connected to the up-and-down reciprocating unit, for driving the up-and-down reciprocating unit to reciprocate upward and downward.

2. The apparatus of claim 1, wherein the up-and-down reciprocating unit comprises:
a driving unit connecting shaft for receiving rotation force generated from the driving unit;
an eccentric rotation unit eccentrically-connected to the driving unit connecting shaft, the eccentric rotation unit having a first eccentric rotation shaft and a second eccentric rotation shaft disposed to have an angular difference of 180° from each other; and
a first link unit and a second link unit respectively having one end hinge-coupled to the respective other ends of the moving panels, and the other end rotatably coupled to the first and the second eccentric rotation shafts.

3. The apparatus of claim 1, wherein the up-and-down reciprocating unit is installed at both ends of the moving panel.

4. The apparatus of claim 3, wherein reciprocating units installed at both ends of the moving panels are connected to each other by a linking unit so that a driving force can be transmitted from the one up-and-down reciprocating unit connected to the driving unit to the other up-and-down reciprocating unit facing the one the up-and-down reciprocating unit connected to the driving unit.

5. The apparatus of claim 4, wherein the linking unit is configured as a link having one end rotatably coupled to the one up-and-down reciprocating unit disposed at one ends of the moving panels, and the other end rotatably coupled to the up-and-down reciprocating unit disposed at the other ends of the moving panels.

6. The apparatus of claim 4, wherein the linking unit comprises:
pulleys disposed at one pair of the up-and-down reciprocating units; and
a belt for connecting the pulleys.

7. The apparatus of claim 2, wherein balance weights having centers of gravity having an angular difference of 180° connecting shaft from an axis of the first eccentric rotation shaft are installed at the up-and-down reciprocating unit, and
wherein the linking unit comprises coupling pins disposed at the balance weights with an angular difference of 180° centering the axis of the first eccentric rotation shaft from the axis of the driving unit connecting shaft; and a link member rotatably coupled to the coupling pins.

8. The apparatus of claim 2, wherein both ends of the eccentric rotation unit are connected to a concentric shaft concentric with the driving unit connecting shaft.

9. The apparatus of claim 8, wherein the concentric shaft is rotatably supported by a shaft supporting bracket.

10. The apparatus of claim 8, wherein a balance weight eccentrically connected to the concentric shaft is further disposed at one end of the concentric shaft.

11. The apparatus of claim 2, wherein the driving unit connecting shaft is connected to a driving shaft of the driving unit by a coupler.

12. The apparatus of claim 2, wherein the driving unit connecting shaft receives rotation force from the driving unit through a belt.

13. The apparatus of claim 2, wherein the driving unit is disposed at a central portion of the moving unit and the driving shaft of the driving unit is connected to the driving unit connecting shaft by a rotation shaft transmitting unit.

14. The apparatus of claim 13, wherein the rotation shaft transmitting unit is implemented as a belt or a link member for connecting the driving unit connecting shaft and the driving shaft to each other.

15. The apparatus of claim 13, wherein the rotation shaft transmitting unit comprises:
a main rotation shaft connected to the driving shaft;
a main shaft supporting bracket for rotatably supporting the main rotation shaft;
a first eccentric rotation shaft connected to the main rotation shaft, and eccentric from the main rotation shaft;
a second eccentric rotation shaft eccentric from the main rotation shaft and
first and second link members having both ends rotatably coupled to the first and second eccentric rotation shafts.

16. The apparatus of claim 15, wherein the first eccentric rotation shaft and the second eccentric rotation shaft are disposed to have an angular difference of 180° centering an axis of the main rotation shaft.

17. The apparatus of claim 2, wherein the driving unit is implemented in one pair so as to be respectively coupled to the driving unit connecting shafts of the moving unit.

18. The apparatus of claim 1, wherein the up-and-down reciprocating unit comprises:
a concentric shaft rotatably supported by a shaft supporting bracket;
first and second eccentric rotation shafts eccentrically coupled to both ends of the concentric shaft, respectively, and having an angular difference from each other; and
a link unit having one end rotatably coupled to the first and second eccentric rotation shafts, and another end hinge-coupled to the first and second moving panels,
wherein the driving unit is coupled to one of the concentric shaft and the first eccentric rotation shaft so as to transmit rotation force.

19. The apparatus of claim 18, wherein the driving shaft of the driving unit is connected to the concentric shaft by a rotation force transmitting unit thus to transmit rotation force to the concentric shaft.

20. The apparatus of claim 19, wherein the rotation force transmitting unit comprises pulleys respectively connected to the driving shaft and the concentric shaft, and a belt for connecting the pulleys.

21. The apparatus of claim 18, wherein the driving shaft of the driving unit is connected to the eccentric rotation shaft by a coupler.

22. The apparatus of claim 18, wherein the first eccentric rotation shaft is rotatably coupled to the link member rotatably coupled to an eccentric coupling shaft eccentrically coupled to the driving shaft of the driving unit.
